(19) United States
(12) Patent Application Publication
(10) Pub. No.: US 2026/0142580 A1
(43) Pub. Date: May 21, 2026

(54) HARDWARE BASED PULSE WIDTH MODULATION (PWM) FOR SYNCHRONOUS RECTIFICATION CONTROL OF LLC CONVERTERS

(71) Applicant: TEXAS INSTRUMENTS INCORPORATED, Dallas, TX (US)

(72) Inventors: Longqi LI, Maoming City (CN); Zhenyu YU, Sugar Land, TX (US)

(21) Appl. No.: 18/952,553

(22) Filed: Nov. 19, 2024

(51) Int. Cl. H02M 3/335; H02M 3/00

(52) U.S. Cl. CPC H02M 3/33592; H02M 3/01; H02M 3/33571

(57) ABSTRACT

An apparatus and method include a converter including a transformer that includes a primary winding and a secondary winding, as well as a first set of controllable switches coupled to the primary winding of the transformer. A second set of controllable switches is coupled to the secondary winding of the transformer, and a control circuit is configured to generate a first set of signals to control the first set of controllable switches and to generate a second set of signals to control the second set of controllable switches. The control circuit is configured to generate the second set of signals to turn off the second set of controllable switches collectively based on determining that the first set of signals turns off the first set of controllable switches collectively.

### CROSS REFERENCE TO RELATED APPLICATIONS

The present application relates to U.S. Patent Application No. 18/356,221, filed July 21, 2023, and titled “ADAPTIVE BURST MODE CONTROL,” and U.S. Patent Application No. 18/674,698, filed May 24, 2024, and titled “CONTROL SYSTEM FOR LLC VOLTAGE CONVERTER USING UP-DOWN COUNTER CONFIGURED TO REACT TO COMPARATOR OUTPUT,” which are hereby incorporated herein by reference in their entirety.

### BACKGROUND

An Inductor-Inductor-Capacitor (LLC) converter, or LLC resonant converter, is a type of power converter that employs an LLC resonant circuit for efficient energy conversion. An LLC converter typically includes two inductors and a capacitor arranged in a resonant configuration, which allows for soft switching. More particularly, the arrangement of inductors and capacitor comprise a resonant tank that is tuned to resonate at a specific frequency. This tuning minimizes switching losses, making LLC converters suitable for applications like power supplies in electric vehicles, renewable energy systems, and high-frequency applications. The secondary side rectifier diode conduction loss is one of the major losses of conventional LLC converters. Synchronous rectification (SR) technology uses controllable switches (e.g., MOSFETs) instead of rectifier diodes. The controllable switches are turned on when rectified current passes through and turned off the rest of the time. Since the controllable switch has a small on-resistance, the large loss of the on-resistance on the diode is reduced. The use of controllable switches adds operating complexity to LLC converters. Thus, it is desirable to have a synchronous rectification control scheme for LLC converters.

### SUMMARY

In accordance with at least one example of the disclosure, an apparatus comprises a converter including a transformer that includes a primary winding and a secondary winding, as well as a first set of controllable switches coupled to the primary winding of the transformer. A second set of controllable switches is coupled to the secondary winding of the transformer, and a control circuit is configured to generate a first set of signals to control the first set of controllable switches and to generate a second set of signals to control the second set of controllable switches. The control circuit is configured to generate the second set of signals to turn off the second set of controllable switches collectively based on determining that the first set of signals turns off the first set of controllable switches collectively.

In accordance with at least one example of the disclosure, an apparatus comprises a control circuit configured to generate a first set of signals to control a first set of controllable switches at a primary-side of an inductor-inductor-capacitor (LLC) converter and to generate a second set of signals to control a second set of controllable switches at a secondary-side of the LLC converter. The control circuit is configured to generate the second set of signals to turn off the second set of switches collectively based on determining that the first set of signals turns off the first set of controllable switches collectively.

In accordance with at least one example of the disclosure, a method of operating a pulse width modulation (PWM) controllable system includes receiving a first plurality of PWM control signals corresponding to a primary-side of a converter, where a first set of switches of the primary-side is controllable by the first plurality of PWM control signals. The method additionally includes generating a second plurality of PWM control signals configured to turn off a second set of switches of the converter based on a rising edge of the first plurality of PWM control signals.

### BRIEF DESCRIPTION OF THE DRAWINGS

FIG. 1 is a schematic diagram of a power converter system in accordance with various examples.

FIG. 2 is a timing diagram of primary-side and secondary-side pulse width modulation (PWM) signals generated by a power converter system in accordance with various examples.

FIG. 3 is a block diagram of a secondary-side control signals generation circuit configured to determine secondary-side PWM control signals based on primary-side PWM control signals in accordance with various examples.

FIG. 4 is a timing diagram that shows primary-side PWM control signals as modified by a secondary-side control signal generation circuit to output secondary-side PWM control signals in accordance with various examples.

FIG. 5 is a flowchart of a method for generating secondary-side PWM control signals based on primary-side PWM control signals in accordance with various examples.

FIG. 6 is a block diagram of a power converter device in accordance with various examples.

### DETAILED DESCRIPTION

LLC resonant converters are commonly used in various power applications. To reduce conduction losses, traditional rectification diodes are replaced with controllable switches such as metal-oxide-semiconductor field-effect transistors (MOSFETs). The MOSFETs are digitally controlled for flexibility and scalability considerations. Pulse width modulation (PWM) control signals control the switching of the MOSFETs to ensure synchronous rectification and avoid short circuits.

Typically, control circuits such as control logic blocks are specifically engineered to determine the secondary-side PWM signals that achieve synchronous rectification control. Put another way, the control logic blocks are configured to control the switching of the MOSFETs in such a manner that the gate voltage of each MOSFET is synchronized with the phase of the secondary-side current. While effective, the configured control logic blocks can be costly and complex to implement. More particularly, different control logic blocks must be engineered for and tailored to each different application. Additionally, space must be allocated for the control logic blocks and their connectivity with other control elements can be unique to each logic block function.

Examples described herein overcome prior limitations by utilizing capability of existing hardware of an electronic device (e.g., a microcontroller) to determine the secondary-side PWM signals based on primary-side PWM signals, rather than adding additional control logic blocks. The determination and MOSFET switching are achieved in hardware without reliance on additional configured logic blocks. Instead, existing hardware that already performs other functions in a power converter is leveraged to achieve synchronous rectification based on the primary-side PWM signals. To this end, an illustrative system has a converter that includes a transformer having a primary winding and a secondary winding, as well as a first set of controllable switches coupled to the primary winding of the transformer. A second set of controllable switches is coupled to the secondary winding of the transformer. A control circuit is configured to generate a first set of signals to control the first set of controllable switches and a second set of signals to control the second set of controllable switches. The control circuit is configured to generate the second set of signals to turn off the second set of controllable switches collectively based on determining that the first set of signals turns off the first set of controllable switches collectively.

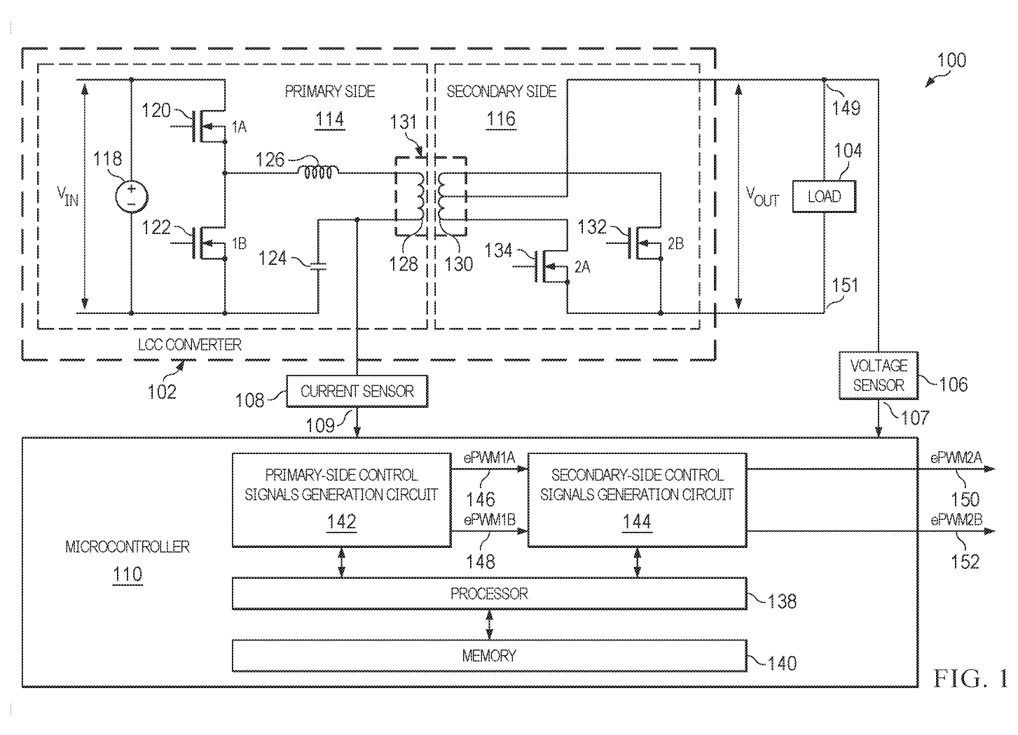

FIG. 1 is a functional block and circuit diagram of an example of a power converter system 100. The power converter system 100 is configured to convert an alternating current (AC) voltage to a direct current (DC) voltage. The power converter system 100 includes an LLC converter 102, a load 104, a voltage sensor 106, a current sensor 108, and a microcontroller 110. The LLC converter 102 includes a primary-side 114 and a secondary-side 116 of a transformer 131. The primary-side 114 includes a voltage source 118, a high side transistor, or switch 120, a low side switch 122, a capacitor 124, an inductor 126, and a primary winding 128 of the transformer 131. Together, the inductor 126, a magnetizing inductance of the primary winding 128, and the capacitor 124 form an LLC resonant tank circuit. The resonance of the LLC tank circuit allows for software switching of the switches 120 and 122. Accordingly, the LLC converter 102 is referred to as a resonant power converter. The inductor 126 may be, for example, an external inductor or a leakage inductance of the transformer 131. An input voltage V_{IN} of the LLC converter 102 is a voltage provided by the voltage source 118. The secondary-side 116 includes a secondary winding 130 of the transformer 131, a first rectifier switch 132, and a second rectifier switch 134.

On the primary-side 114, a positive terminal of the voltage source 118 is connected to a first terminal of the high side switch 120. A second terminal of the high side switch 120 is connected to a first terminal of the low side switch 122 and a first terminal of the inductor 126. A second terminal of the inductor 126 is connected to the first terminal of the primary winding 128. The primary winding 128 is magnetically coupled to the secondary winding 130. A second terminal of the primary winding 128 is connected to a first terminal of the capacitor 124. A second terminal of the capacitor 124 is connected to a second terminal of the low side switch 122 and a negative terminal of the voltage source 118.

On the secondary-side 116, a first terminal of the secondary winding 130 is connected to a first terminal of the first switch 132. A second terminal of the secondary winding 130 is connected to a first terminal of the second switch 134. A center tap of the secondary winding 130 is connected to a first terminal of the load 104 via the first output terminal 149. A second terminal of the load 104 is connected, via a second output terminal 151, to second terminals of the first and second switches 132, 134. An output voltage V_{OUT} of the LLC converter 102 is a voltage between the first and second output terminals 149 and 151, that is, a voltage across the load 104. The first output terminal 149 is connected to an input of the voltage sensor 106. The first and second switches 132, 134 are controllable switches such as MOSFETs, instead of didoes, and are controlled using respective control terminals so that the first and second switches 132, 134 form a rectifier to provide the DC output voltage V_{OUT} on the secondary-side 116.

When the high side transistor 120 is on and the low side transistor 122 is off, current flowing from the positive terminal of the voltage source 118 increases through the inductor 126 and the primary winding 128. While current flows through the primary winding 128 towards the capacitor 124 in a first direction, the capacitor 124 charges. The primary winding 128 generates a magnetic flux that causes a magnetic core (not shown) to store magnetic energy with a first polarity. When the high side transistor 120 is off and the low side transistor 122 is on, current flows from the capacitor 124 through the primary winding 128 and the inductor 126 in a second direction opposite to the first direction. The capacitor 124 discharges and the primary winding 128 generates a magnetic flux that causes the magnetic core to store magnetic energy with a second polarity. Magnetic flux generated by the primary winding 128 induces voltage in the secondary winding 130 that is rectified by the first and second transistors 132 and 134 to provide direct current (DC) power to the load 104.

Outputs 107, 109 of the voltage sensor 106 and the current sensor 108, respectively, are connected to the microcontroller 110. The output 107 represents a measurement of the output voltage V_{OUT} at the secondary-side 116, while the output 108 represents a measurement of the current flowing through the primary winding 128 on the primary-side 114. The microcontroller 110 may include a processor 138 configured to communicate with a memory 140. The microcontroller further includes a primary-side control signals generation circuit 142 and a secondary-side control signals generation circuit 144. In some examples, the primary-side control signals generation circuit 142 and secondary-side control signals generation circuit 144 may be implemented by the processor 138. Put another way, circuits 142 and 144 may be part of the processor 138. The primary-side control signals generation circuit 142 outputs enhanced PWM signals (e.g., the ePWM1A signal 146 and the ePWM1B signal 148) to the secondary-side control signals generation circuit 144. As shown in FIG. 1, the secondary-side control signals generation circuit 144 processes the ePWM1A signal 146 and the ePWM1B signal 148 to generate the ePWM2A signal 150 and the ePWM2B signal 152. As described herein, the ePWM2A and the ePWM2B signals 150, 152 are configured to operate (e.g., turn on and off) the 2A switch 134 and the 2B switch 132, respectively, while the ePWM1A and ePWM1B signals 146, 148 are configured to operate the 1A switch 120 and 1B switch 122, respectively. The ePWM2A and the ePWM2B signals 150, 152 are generated based on determining that the ePWM1A and the ePWM1B signals 146, 148 turn off the 1A switch 120 and the 1B switch 122, collectively. Put another way, the ePWM2A and the ePWM2B signals 150, 152 are generated based on determining that both the 1A switch 120 and 1B switch 122 are turned off simultaneously by the ePWM1A and the ePWM1B signals 146, 148.

The LLC converter 102 includes a voltage loop, or an outer voltage loop and an inner current loop that work together, to regulate AC current to achieve a desired output voltage, V_{OUT}. The voltage loop includes an error amplifier (not shown), e.g., a proportional control or a proportional-integral (PI) control, which operates on an error between the output 107 from the voltage sensor 106 and a voltage reference value to generate an output. When there is not additional inner current loop, the microcontroller 110 uses the output of the voltage loop to determine the PWM signals 146, 148 for the primary-side 114 power switches 120, 122. If there is an inner current loop, the output of the voltage loop is provided to the inner current loop. The inner current loop further includes an error amplifier (not shown) that operates on an error between the output of the voltage loop and the output 109 from the current sensor 108 to generate an output. The microcontroller 110 then uses the output of the current loop to determine the PWM signals 146, 148 for the primary-side 114 power switches 120, 122. Put another way, the voltage loop may receive a Vdc feedback measurement (e.g., the output voltage V_{OUT}160) and a voltage reference value that is set by a customer. The voltage loop generates a primary current reference for the current loop (e.g., using a proportional control or a proportional-integral control) based on V_{OUT}160 and the voltage reference value. The inner current loop receives the primary current reference from the voltage current loop, along with a primary-side current measurement (e.g., via current sensor 108). The inner current loop uses the two inputs to generate the primary-side switching signals (i.e., the ePWM1A and the ePWM1B signals 146, 148).

More particularly, the ePWM1A and the ePWM1B signals 146, 148 are generated based on the DC voltage (e.g., operating in voltage control mode) or both the DC voltage and a current flowing through the primary winding 228 of the transformer 131 (e.g., operating in current control mode). Voltage-mode control, also called direct frequency control, is a single-loop method that directly adjusts the switching frequency in response to output voltage changes. Current-mode control is a multiple-loop control method based on measurements from both the inner current loop and the outer voltage loop. The inner loop may be faster than the outer loop to thus provide improved dynamic response and enhanced stability for the LLC converter 102.

When the waveforms of the ePWM1A and the ePWM1B signals 146, 148 are known, the secondary-side control signals generation circuit 144 can generate the ePWM2A and the ePWM2B signals 150, 152 based on the ePWM1A and the ePWM1B signals 146, 148. Further, as described below, the secondary-side PWM control signals (e.g., the ePWM2A and the ePWM2B signals 150, 152) are generated using capability of existing hardware of a microcontroller without the added costs and complexity of an additional control logic block.

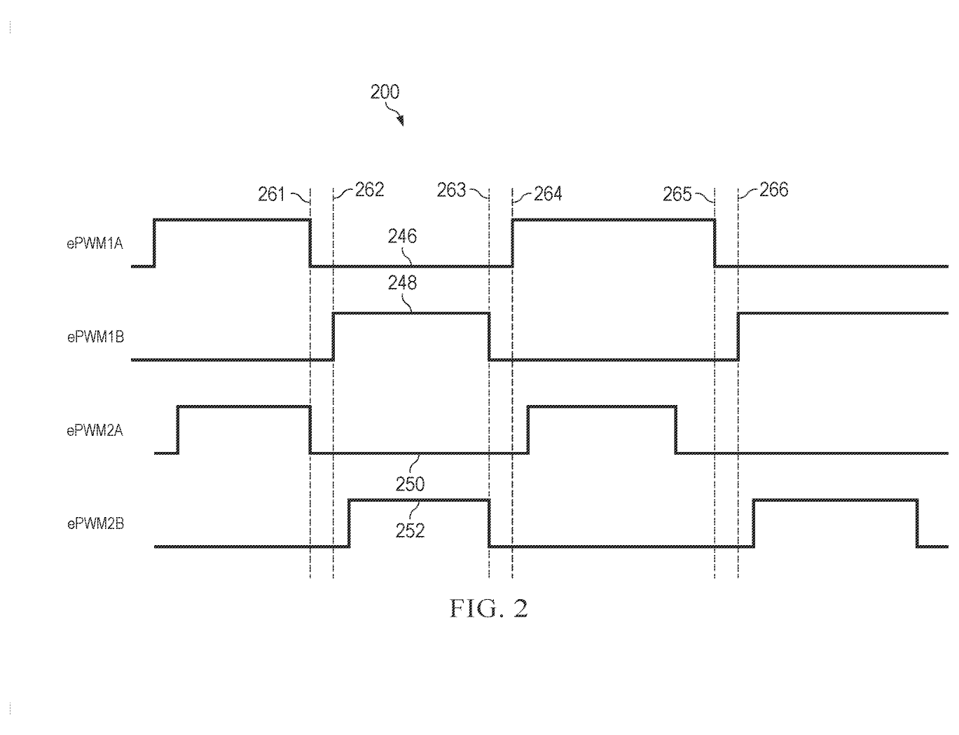

Examples of such primary-side and secondary-side PWM signals are shown in FIG. 2. For purposes of illustration, as described herein, a PWM signal is asserted to a logic high state (or a high voltage level) to turn on a corresponding switch, while the PWM signal is de-asserted to a logic low state (or a low voltage level) to turn off the corresponding switch. For instance, primary-side signals, the ePWM1A signal 246 and the ePWM1B signal 248, may be generated by a primary-side control signals generation circuit, such as the primary-side control signals generation circuit 142 of FIG. 1. Secondary-side signals, the ePWM2A signal 250 and the ePWM2B signal 252, may be generated by a secondary-side control signals generation circuit, such as the secondary-side control signals generation circuit 144 of FIG. 1. As described herein, the ePWM2A signal 250 and the ePWM2B signal 252 comprise synchronization rectification control signals configured to control MOSFETs in such a manner that the gate voltage of the MOSFET is synchronized with the phase of the current flowing through a secondary winding of the LLC converter.

The secondary-side signals (i.e., the ePWM2A signal 250 and the ePWM2B signal 252) are collectively de-asserted (e.g., are ensured to be de-asserted) to a logic low state at times corresponding to when the primary-side signals (i.e., the ePWM1A signal 246 and the ePWM1B signal 248) collectively switch off the primary-side switches. Put another way, both the ePWM2A and the ePWM2B signals 250, 252 are de-asserted based on determining that the ePWM1A and the primary-side ePWM1A and ePWM1B signals 246, 248 turn off both the 1A switch 120 and 1B switch 122. More particularly, dashed lines 261-266 indicate times when both the ePWM1A signal 246 and the ePWM1B signal 248 turn off the primary-side switches. As illustrated in FIG. 2, the ePWM2A signal 250 and the ePWM2B signal 252 turn off the secondary-side switches during timespans bounded by dashed lines 261 and 262, 263 and 264, and 265 and 266, when the ePWM1A signal 246 and the ePWM1B signal 248 also turn off the primary-side switches collectively.

In this manner, an implementation of the system uses the PWM control signals on the primary-side (i.e., the ePWM1A signal 246 and the ePWM1B signal 248) to generate the secondary-side PWM control signals (i.e., the ePWM2A signal 250 and the ePWM2B signal 252). The signals achieve accurate control of switch timing in multiple PWM modules in the absence of a configured logic block.

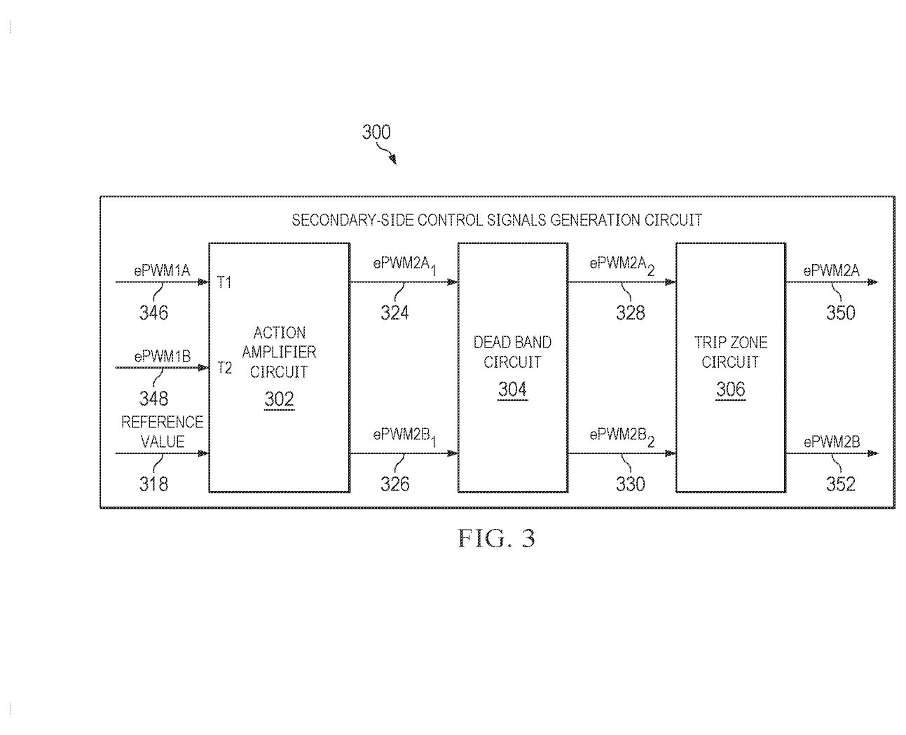

FIG. 3 is a block diagram of an implementation of a secondary-side control signal generation circuit 300 configured to determine secondary-side PWM control signals based on primary-side PWM control signals. The secondary-side control signal generation circuit 300 is an example of a secondary-side control signal generation circuit and may be similar to the secondary-side control signal generation circuit 144 of FIG. 1.

Turning more particularly to FIG. 3, a secondary-side control signal generation circuit 300 includes an action qualifier circuit 302, a dead band circuit 304, and a trip zone circuit 306. As such, the action qualifier circuit 302, the dead band circuit 304, and the trip zone circuit 306 are configured to collectively modify the ePWM1A signal 346 and the ePWM1B signal 348 in order to generate the ePWM2A signal 350 and the ePWM2B signal 352. As described below, the submodule circuits 302, 304, and 306 are existing hardware components of a microcontroller and are configured in ways different from their conventional purposes to generate the ePWM2A signal 350 and the ePWM2B signal 352 (e.g., the synchronization rectification control signals) based on the ePWM1A signal 346 and the ePWM1B signal 348. The ePWM1A signal 346 and the ePWM1B signal 348 shown in FIG. 3 may be similar to the signals 146 and 148 of FIG. 1, as well as to the signals 246 and 248 of FIG. 2. The ePWM2A signal 350 and the ePWM2B signal 352 shown in FIG. 3 may be similar to the signals 150 and 152 of FIG. 1, as well as to the signals 250 and 252 of FIG. 2.

As shown in FIG. 3, the action qualifier circuit 302 receives a first set of PWM signals (i.e., primary-side PWM signals ePWM1A 346 and ePWM1B 348) and a reference value (i.e., a reference value 318), and generates a second set of PWM signals (i.e., first intermediate secondary-side PWM signals ePWM2A1324 and ePWM2B1326). The action qualifier 320 is configured to receive a counter value (not shown) or generate a counter value on its own which increments (and then resets) in order to generate the first intermediate secondary-side PWM signals. The counter value is based on the received primary-side PWM signals and is used to generate the first intermediate secondary-side PWM signals based on a comparison of the counter value to the reference value. For example, the action qualifier circuit 302 receives a programmable reference value (e.g., from a register) for comparison against the counter value. When the counter value is greater than the reference value, the PWM signal changes state. That is, the action qualifier circuit 302 defines the duty cycle of the first intermediate secondary-side of PWM signals according to the sampled points at which the amplitude of the counter value matches (or exceeds) the reference value. In some examples, the reference value 318 may be set to a value corresponding to one half of a resonant period of the LLC converter. A corresponding PWM signal is then accordingly generated to toggle between a logic high state and a logic low state at half of the resonant period of the LLC converter.

In the implementation of FIG. 3, the action qualifier circuit 302 is configured to turn on the secondary-side switches corresponding to rising edges of the primary-side PWM control signals. That is, the ePWM2A signal 350 and the ePWM2B signal 352 turn on the secondary-side switches at times that correspond to the rising edges of the primary-side PWM control signals (i.e., the ePWM1A signal 346 and the ePWM1B signal 348).

The action qualifier circuit 302 is further configured to clamp the secondary-side frequency by turning off at least one of the secondary-side switches when the secondary-side frequency is clamped. More specifically, the action qualifier circuit 302 generates turn-off signals for the ePWM2A signal 350 and/or the ePWM2B signal 352 when the counter value matches (or exceed) the reference value 318. Accordingly, the reference value 318 is used to modify the pulse width of the ePWM2A signal 350 and the ePWM2B signal 352. As described herein, the reference value 318 includes a predetermined value that may be stored in a register. Further, the reference value 318 may represent one half of the resonant period of an LLC converter. As such, the clamping function defines a maximum turn-on period of the secondary-side switches.

The action qualifier circuit 302 may include two input pins T1 and T2 that conventionally receive signals representing fault events for protection purposes. However, as described herein, the first set of PWM signals (i.e., ePWM1A signal 346 and ePWM1B signal 348) are provided to the T1 and T2 pins in order to generate the first intermediate secondary-side of PWM signals (i.e., ePWM2A1 signal 324 and ePWM2B1 signal 326). Put another way, the T1 and T2 inputs of the action qualifier circuit 302 are configured in ways different from their conventional purposes for generation of the first intermediate secondary-side PWM signals. Alternatively, the first set of PWM signals may be considered as “internal fault events” for the action qualifier circuit 302 to determine the secondary-side PWM signals based on the first set of PWM signals.

The dead band circuit 304 is configured to avoid short circuits of the LLC converter. In the particular implementation of FIG. 3, the dead band circuit 304 adds a delay to the first intermediate secondary-side PWM control signals (i.e., the ePWM2A1 signal 324 and the ePWM2B1 signal 326), such that the generated second intermediate secondary-side PWM signals (i.e., ePWM2A2328 and ePWM2B2330) include the delay, respectively, relative to the primary-side PWM signals (i.e., the ePWM1A signal 346 and the ePWM1B 348). The added delay ensures proper timing as between the primary-side (i.e., the ePWM1A signal 346 and the ePWM1B signal 348) and secondary-side PWM control signals (i.e., the ePWM2A2 signal 328 and the ePWM2B2 signal 330) to avoid short circuits that might arise. Additionally, the dead band circuit 304 reverses the ePWM2B1 signal 326 to generate the ePWM2B2 signal 330. This is because the action qualifier circuit 302 generates the ePWM2B1 signal 326 in a “reversed” polarity. In some examples, the action qualifier circuit 302 may generate the ePWM2B1 signal 326 in the correct polarity, and accordingly the dead band circuit 304 may not necessarily need to reverse the ePWM2B1 signal 326 anymore in order to generate the ePWM2B2 signal 330.

The trip zone circuit 306 comprises fast, clock independent, logic path to signal output pins to speedily turn off PWM control signals. As the name implies, conventionally the trip zone circuit 306 is configured to “trip” a power converter for protection purposes. However, in the particular implementation of FIG. 3, the trip zone circuit 306 is configured to turn off at least one of the secondary-side switches or de-assert at least one of the secondary-side PWM control signals (i.e., the ePWM2A signal 350 and the ePWM2B signal 352) during a period when the primary-side PWM control signals (i.e., the ePWM1A signal 346 and the ePWM1B signal 348) are simultaneously (e.g., collectively) low. Put another way, the trip zone circuit 306 is configured to generate turn-off signals for the ePWM2A signal 350 and the ePWM2B signal 352 at times that correspond to common low levels of the ePWM1A signal 346 and the ePWM1B signal 348.

In view of the above, the submodule circuits 302, 304, and 306 of the secondary-side control signals generation circuit 300 are each configured to progressively modify one or more of the ePWM1A signal 346 and the ePWM1B signal 348. The progressive modifications of these primary-side PWM control signals enable the generation in hardware of the synchronization rectification control signals, ePWM2A signal 350 and the ePWM2B signal 352.

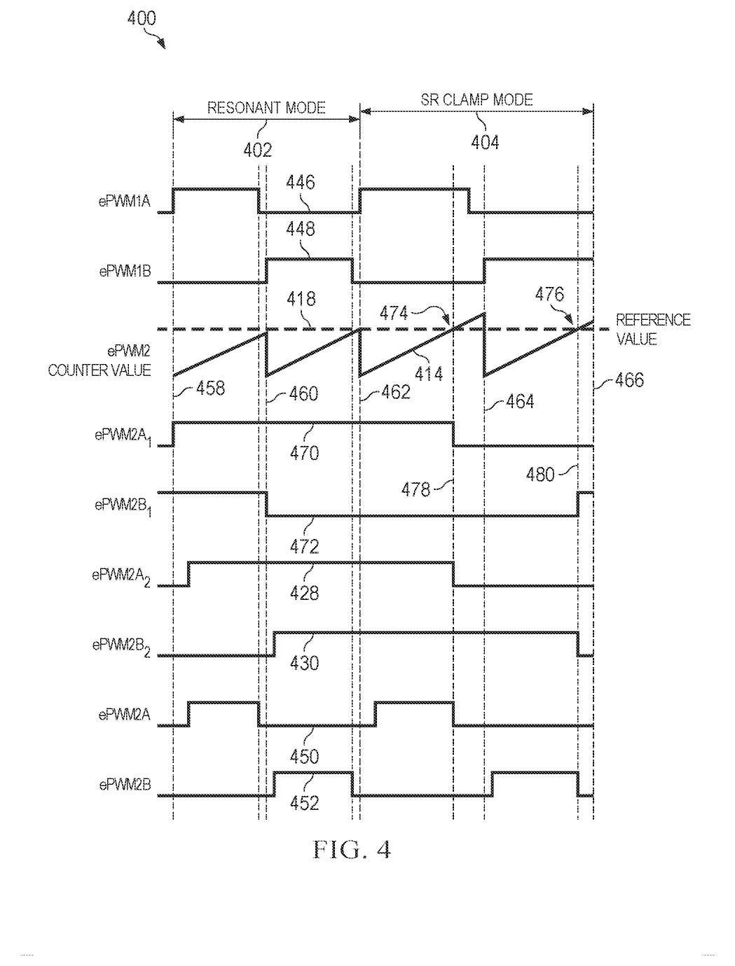

FIG. 4 is a timing diagram 400 that shows a series of transforming waveform signals that illustrate the progressive modifications of the primary-side PWM control signals, the ePWM1A signal 446 and the ePWM1B signal 448, as modified by the secondary-side control signals generation circuit to output the secondary-side PWM control signals, the ePWM2A signal 450 and the ePWM2B signal 452. As described herein, the ePWM1A signals 446 and ePWM1B signal 448 are generated by a primary-side control signals generation circuit (e.g., the primary-side control signals generation circuit 142 of FIG. 1), and the ePWM2A signals 450 and ePWm2B signal 452 are generated by a secondary-side control signals generation circuit (e.g., the secondary-side control signals generation circuit 144 of FIG. 1 which further includes the submodule circuits 302, 304, and 306 of FIG. 3). The modified and intermediate waveform signals could be generated in one example by the secondary-side control signals generation circuit 300 of FIG. 3. Similar to the timing diagram 200 of FIG. 2, FIG. 4 includes the primary-side and secondary-side PWM control signals. However, the timing diagram 400 of FIG. 4 additionally shows intermediate waveform signals (e.g., transitioning stages) of the generation of the ePWM2A signal 450 and the ePWM2B signal 452 based on the ePWM1A 446 signal and the ePWM1B 448 signal. In an example, intermediate waveforms are generated by the different submodule circuits of the secondary-side control signals generation circuit, e.g., as described above with reference to FIG. 3.

Turning more particularly to FIG. 4, the timing diagram 400 includes primary-side signals, the ePWM1A signal 446 and the ePWM1B signal 448. As described herein, the primary-side signals are generated by a primary-side control signals generation circuit, such as the primary-side control signals generation circuit 142 of FIG. 1. For instance, the primary-side signals may be generated using a voltage loop (e.g., operating in a voltage control mode) or an outer voltage loop and an inner current loop (e.g., operating in a current control mode). FIG. 4 additionally includes secondary-side signals, ePWM2A signal 450 and ePWM2B signal 452. The secondary-side signals are generated by a secondary-side control signals generation circuit, such as the secondary-side control signals generation circuit 144 of FIG. 1. In terms of FIG. 3, the ePWM1A signal 446 and the ePWM1B signal 448 may be similar to the ePWM1A signal 346 and the ePWM1B signal 348, respectively, received at the action qualifier circuit 302. The reference value 418 may be similar to the reference value 318, received at the action qualifier circuit 302. The counter value 414 may be similar to the counter value, received at (not shown) or generated by the action qualifier circuit 302, which is compared with the reference value 318. The ePWM2A1 signal 470 and ePWM2B1 signal 472 may be similar to the ePWM2A1 signal 324 and ePWM2B1 signal 326, respectively, output from the action qualifier circuit 302. The ePWM2A2 signal 428 and ePWM2B2 signal 430 may be similar to the ePWM2A2 signal 328 and ePWM2B2 signal 330, respectively, output from the dead band circuit 304. The ePWM2A signal 450 and the ePWM2B signal 452 may be similar to the ePWM2A signal 350 and the ePWM2B signal 352, respectively, output from the trip zone circuit 306.

FIG. 4 includes an ePWM2 counter value 414. As described herein, the ePWM counter value 414 may be generated based on the ePWM1A signal 446 and ePWM1B signal 448. For instance, the ePWM counter value 414 may include a sawtooth waveform, and the ePWM counter value 414 may be reset at a rising edge of a first signal of the ePWM1A signal 446 and ePWM1B signal 448 that follows a prior falling edge of a second signal of the ePWM1A signal 446 and ePWM1B signal 448. For instance, as illustrated by the dashed line 458, the ePWM counter value 414 first starts from zero to increment. Next, the ePWM counter value 414 is reset back to zero at the rising edge of the ePWM1B signal 448 following a falling edge of the ePWM1A signal 446, as illustrated by the dashed line 460. Next, the ePWM counter value 414 again increments. Next, the ePWM counter value 414 again gets reset at the rising edge of the ePWM1A signal 446 following a falling edge of the ePWM1B signal 448, as illustrated by the dashed line 462. This process repeats to thus generate the sawtooth waveform for the ePWM counter value 414. Based on the reset timing of the ePWM counter value 414, operation of the LLC converter may be divided into a resonant mode 402 and an SR clamp mode 404. The resonant mode 402 corresponds to operation of the LLC converter when the ePWM counter value 414 is less than a reference value 418. In contrast, the SR clamp mode 404 corresponds to operation of the LLC converter when the ePWM counter value 414 matches or exceeds the reference value 418. The clamping mode 404 operation mandates a maximum turn-on period of the secondary-side switches.

In the example of FIG. 4, the ePWM2A1 signal 470 and the ePWM2B1 signal 472 turn on the secondary-side switches at times that correspond to the rising edges of the primary-side PWM control signals (i.e., the ePWM1A signal 446 and the ePWM1B signal 448, respectively). That is, ePWM2A1 signal 470 is asserted by the rising edge of the ePWM1A signal 446, as illustrated by the dashed line 458. Similarly, the ePWM2B1 signal 472 would be asserted at the rising edge of the ePWM1B signal 448, as illustrated by the dashed line 460. However, in this example, given the way of the operation of the action qualifier circuit 302, the ePWM2B1 signal 472 is de-asserted at the dashed line 460. The ePWM2B1 signal 472 is further reversed by a dead band circuit to thus generate an asserted signal corresponding to the rising edge of the ePWM1B signal 448.

Once turned on, the secondary-side switches remain on until the ePWM counter value 414 matches (or exceeds) the reference value 418. More particularly, the reference value 418 is used to clamp the maximum turn-on period of the secondary-side switches where the ePWM2 counter value 414 exceeds the reference value 418 at 474 and 476. The clamping causes at least the ePWM2A1 signal 470 and the ePWM2B1 signal 472 to turn off the secondary-side switches where the counter value 414 intersects dotted lines 478 and 480. For instance, the action qualifier circuit 302 of FIG. 3 could assert the ePWM2A1 signal 470 and de-assert the ePWM2B1 signal 472 at times corresponding to when the reference value 418 is exceeded by the ePWM2 counter value 414. After thus modifying the primary-side signals, the ePWM1A signal 446 and the ePWM1B signal 448, the action qualifier circuit outputs the ePWM2A1 signal 470 and the ePWM2B1 signal 472 for further hardware processing.

The ePWM2A1 signal 470 and the ePWM2B1 signal 472 are modified by adding a predetermined delay to generate the ePWM2A2 signal 428 and the ePWM2B2 signal 430. In an example, the added delay comprises an original rising edge delay. A dead band circuit, such as the dead band circuit 304 of FIG. 3, adds a delay to the intermediate secondary-side PWM control signals (i.e., the ePWM2A1 signal 324 and the ePWM2B1 signal 326). For instance, as shown in FIG. 4, the rising edge of the ePWM2A2 signal 428 is delayed relative to a corresponding rising edge of the ePWM2A1 signal 470. As described above, the ePWM2B2 signal 430 is a reversed version of the ePWM2B1 signal 472, and thus the rising edge of the ePWM2B2 signal 430 is delayed relative to a corresponding falling edge of the ePWM2B1 signal 472. The added delay ensures proper timing as between the primary-side (i.e., the ePWM1A signal 446 and the ePWM1B signal 448) and secondary-side PWM control signals (i.e., the ePWM2A2 signal 428 and the ePWM2B2 signal 430) to avoid short circuits.

The ePWM2A2 signal 428 and the ePWM2B2 signal 430 are further modified based on the ePWM1A signal 446 and the ePWM1B signal 448 to generate the ePWM2A signal 450 and the ePWM2B signal 452. More particularly, the ePWM2A2 signal 428 and the ePWM2B2 signal 430 are de-asserted (to turned off the secondary-side switches) when the primary-side PWM control signals (i.e., the ePWM1A signal 446 and the ePWM1B signal 448) are collectively low. Put another way, the ePWM2A2 signal 428 and the ePWM2B2 signal 430 are de-asserted to a logic low state at times that correspond to common low levels of the ePWM1A signal 446 and the ePWM1B signal 448. The ePWM2A signal 450 and the ePWM2B signal 452 are the resultant waveform signals. The modification in an example is performed by a trip zone circuit, such as the trip zone circuit 306 of FIG. 3.

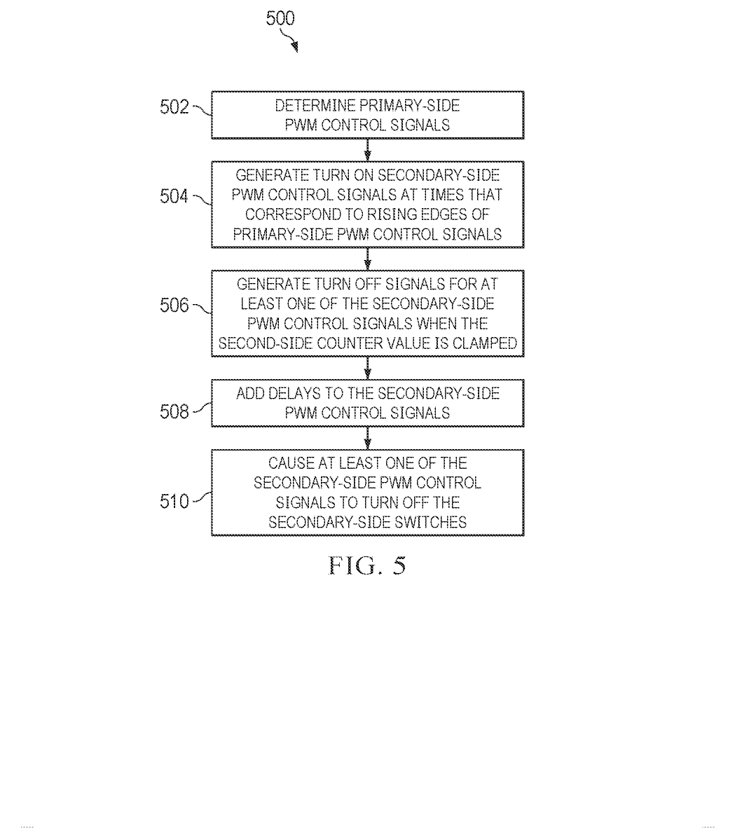

FIG. 5 is a flowchart of an example of a method 500 of generating secondary-side PWM control signals based on primary-side PWM control signals in accordance with various examples. The illustrative method 500 may be performed by the illustrative systems described herein, including the power converter system 100 of FIG. 1 and the secondary-side control signals generation circuit 300 of FIG. 3.

Turning more particularly to the flowchart, the method 500 determines at 502 the primary-side PWM control signal. As described herein, the processes of the method 500 generate the primary-side PWM control signals in a voltage operation mode or a current operation mode. As described herein, the primary-side PWM control signals are determined from the DC voltage, a current flowing through the primary winding of the transformer, or a combination thereof. For example, the inner loop of the LLC converter 102 provides the ePWM1A and the ePWM1B signals 146, 148.

With the primary-side PWM control signals known at 502, the method 500 generates turn-on signals for the secondary-side PWM signals at 504 at times that correspond to rising edges of the primary-side PWM control signals. For example, the action qualifier circuit 302 of FIG. 3 is configured to assert the ePWM2A signal 350 and de-assert the ePWM2B signal 352 at times that correspond to the rising edges of the ePWM1A signal 346 and the ePWM1B signal 348.

At 506, the method 500 generates turn-off signals for at least one of the secondary-side PWM control signals when the secondary-side PWM counter value is clamped. For instance, the action qualifier circuit 302 of FIG. 3 is configured to clamp the secondary-side frequency by turning off at least one of the secondary-side PWM control signals when the secondary-side frequency is clamped. More specifically, the action qualifier circuit 302 causes the ePWM2A signal 350 and/or the ePWM2B signal 352 to turn (or keep) off the secondary-side switches when a reference value 318 is matched or exceeded by a counter value.

A delay is added at 508 to the secondary-side PWM control signals. For example, the dead band circuit 304 of FIG. 3 adds a delay to the ePWM2A1 signal 324 and the ePWM2B1 signal 326 to ensure proper timing as between the ePWM1A signal 346 and the ePWM1B signal 348 and secondary-side PWM control signals. In some examples, the dead band circuit may additionally reverse one of the secondary-side PWM control signals.

At 510, the method 500 includes causing at least one of the secondary-side PWM control signals to turn off the secondary-side switches during a common low level of the primary-side PWM control signals. For instance, the trip zone circuit 306 of FIG. 3 is configured to de-assert at least one of the ePWM2A signal 350 and the ePWM2B signal 352 during a period when the ePWM1A signal 346 and the ePWM1B signal 348 turn off the primary-side switches collectively.

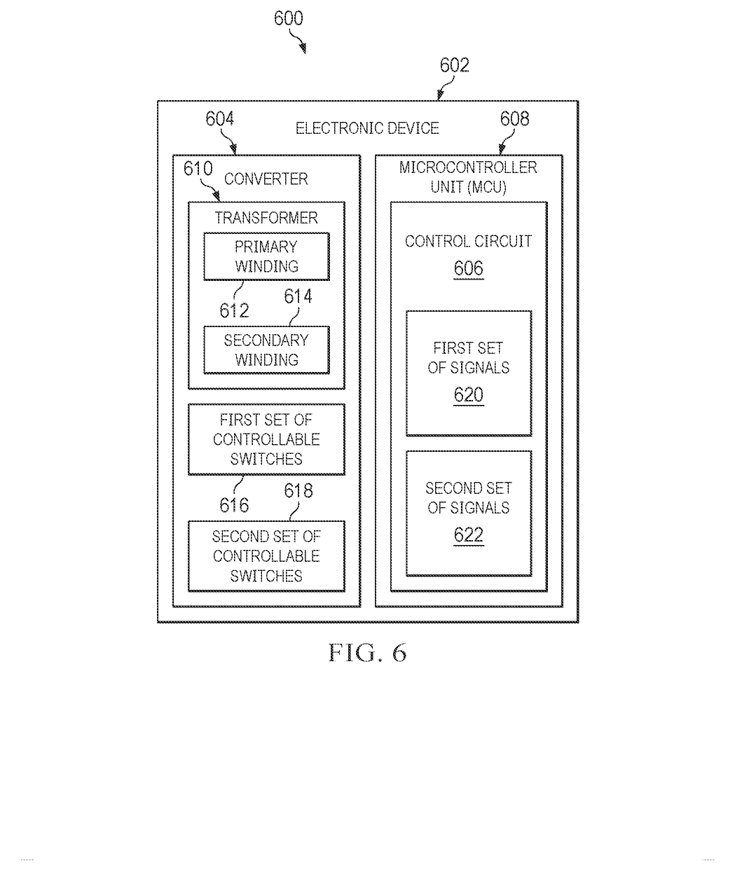

FIG. 6 is a block diagram of an example of a system 600 that includes an electrical device 602, such as an electronic vehicle, a household appliance, or a medical device. The electrical device 602 includes a converter 604 and a control circuit 606. The control circuit 606 of the example is included in a microcontroller unit 608.

The converter 604 of FIG. 6 includes a transformer 610 that includes primary and secondary windings 612, 614. The transformer may be similar to the transformer 131 of the power converter system 100 of FIG. 1. The converter 604 additionally includes first and second sets of controllable switches 616, 618. The first and second sets of controllable switches 616, 618 are respectively coupled to the primary winding and secondary windings 612, 614 of the transformer 610.

The control circuit 606 of FIG. 6 is configured to generate first and second sets of signals 620, 622. The first and second sets of signals 620, 622 are configured to control the first and second sets of controllable switches 616, 618, respectively. As described herein, the control circuit 606 is configured to generate the second set of signals 622 to turn off the second set of controllable switches 618 collectively based on determining that the first set of signals 620 turns off the first set of controllable switches 616 collectively.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

A circuit or device that is described herein as including certain components may instead be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be coupled to at least some of the passive elements and/or the sources to form the described structure either at a time of manufacture or after a time of manufacture, for example, by an end-user and/or a third-party.

While certain components may be described herein as being of a particular process technology, these components may be exchanged for components of other process technologies. Circuits described herein are reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

Uses of the phrase “ground voltage potential” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/- 10 percent of that parameter. Modifications are possible in the described examples, and other examples are possible within the scope of the claims.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device, or a semiconductor component. Furthermore, a voltage rail or more simply a “rail,” may also be referred to as a voltage terminal and may generally mean a common node or set of coupled nodes in a circuit at the same potential.

What is claimed is:

1. An apparatus comprising:
a converter comprising:
a transformer comprising a primary winding and a secondary winding;
a first set of controllable switches coupled to the primary winding of the transformer; and
a second set of controllable switches coupled to the secondary winding of the transformer; and
a control circuit configured to:
generate a first set of signals to control the first set of controllable switches; and
generate a second set of signals to control the second set of controllable switches,
wherein the control circuit is configured to generate the second set of signals to turn off the second set of controllable switches collectively based on determining that the first set of signals turns off the first set of controllable switches collectively.

2. The apparatus of claim 1, wherein the control circuit comprises a counter configured to generate a counter value based on the first set of signals, wherein the control circuit is configured to generate the second set of signals based on a comparison of the counter value to a reference value.

3. The apparatus of claim 2, wherein the control circuit is further configured to generate the second set of signals to turn off the second set of controllable switches based on the comparison indicating that the counter value matches the reference value.

4. The apparatus of claim 2, wherein the control circuit is further configured to reset the counter value based on determining that the first set of signals turns on at least one of the first set of controllable switches.

5. The apparatus of claim 1, wherein the control circuit is further configured to generate the second set of signals to turn on one of the second set of switches based on determining that the first set of signals turns on a corresponding one of the first set of switches.

6. The apparatus of claim 1, wherein the control circuit is further configured to generate the second set of signals based on adding a delay to the first set of signals.

7. The apparatus of claim 1, wherein the converter further comprises a resonant tank configured to couple the first set of controllable switches to the primary winding of the transformer, and wherein the resonant tank comprises an inductor and a capacitor.

8. The apparatus of claim 7, wherein the first set of controllable switches comprises a first set of metal-oxide-semiconductor field-effect transistors (MOSFETs), and the second set of controllable switches comprises a second set of MOSFETs.

9. The apparatus of claim 1, wherein the converter is configured to convert an alternating current (AC) voltage to a direct current (DC) voltage, and wherein the control circuit is configured to generate the first set of signals based on at least one of: the DC voltage, a current flowing through the primary winding of the transformer, or a combination thereof.

10. An apparatus comprising:
a control circuit configured to:
generate a first set of signals to control a first set of controllable switches at a primary-side of an inductor-inductor-capacitor (LLC) converter; and
generate a second set of signals to control a second set of controllable switches at a secondary-side of the LLC converter,
wherein the control circuit is configured to generate the second set of signals to turn off the second set of switches collectively based on determining that the first set of signals turns off the first set of controllable switches collectively.

11. The apparatus of claim 10, wherein the control circuit comprises a counter configured to generate a counter value based on the first set of signals, and wherein the control circuit is configured to generate the second set of signals based on a comparison of the counter value to a reference value.

12. The apparatus of claim 11, wherein the control circuit is further configured to generate the second set of signals to turn off the second set of controllable switches based on the comparison indicating that the counter value matches the reference value.

13. The apparatus of claim 10, wherein the control circuit is further configured to generate the second set of signals to turn on one of the second set of switches based on determining that the first set of signals turns on a corresponding one of the first set of switches.

14. The apparatus of claim 10, wherein the control circuit is further configured to generate the second set of signals based on adding a delay to the first set of signals.

15. The apparatus of claim 10, wherein the first set of controllable switches comprises a first set of metal-oxide-semiconductor field-effect transistors (MOSFETs), and the second set of controllable switches comprises a second set of MOSFETs.

16. The apparatus of claim 1, wherein the control circuit is configured to generate the first set of signals based on at least one of: a DC voltage, a current flowing through a primary winding of a transformer, or a combination thereof.

17. A method of operating a pulse width modulation (PWM) controllable system, the method comprising:
receiving a first plurality of PWM control signals corresponding to a primary-side of a converter, wherein a first set of switches of the primary-side is controllable by the first plurality of PWM control signals; and
generating a second plurality of PWM control signals to turn off a second set of switches of the converter corresponding to a duration in which the first plurality of PWM control signals is simultaneously low.

18. The method of claim 17, further comprising adding a delay to the second plurality of PWM control signals.

19. The method of claim 17, further comprising generating a counter value based on the first plurality of PWM control signals, wherein the second plurality of PWM control signals are generated based on a comparison of the counter value to a reference value.

20. The method of claim 17, wherein the converter is an inductor-inductor-capacitor (LLC) resonant converter.
